(19) United States
(12) Patent Application Publication
(10) Pub. No.: US 2008/0060176 A1
(43) Pub. Date: Mar. 13, 2008

(54) Pocket urn

(76) Inventor: David L. Kopicki, Reading, PA (US)

Correspondence Address: Eugene E. Renz, Jr., 205 North Monroe Street, Media, PA, 19063, US

(21) Appl. No.: 11/827,299

(22) Filed: Jul. 11, 2007

Related U.S. Application Data
(60) Provisional application No. 60/843,973, filed on Sep. 11, 2006.

(51) Int. Cl. A61G 17/08

(52) U.S. Cl. 27/1; 383/74

(57) ABSTRACT

A small urn, referred to as a “pocket urn” is disclosed. The pocket urn serves as a keepsake for the survivors of a loved one. Ashes, or other material from the deceased, such as hair, are stored in the pocket urn. The pocket urn is then able to be carried in a purse, suitcase, or pocket, allowing a user to hold the pocket urn in their hand whenever they feel the need to. By holding the pocket urn, the user can make a psychological connection to their loved one which may provide comfort to the user while going through the grieving process.

### FIELD OF THE INVENTION

The present invention relates generally to storing cremated remains, more specifically to storing cremated remains in a portable manner.

### BACKGROUND

The trends of funeral practices are showing a growing acceptance of cremation. Someone who loses a loved one, such as a child, parent, close friend, or a pet, often needs to memorialize the strong emotional bond resulting from love or friendship. A common practice is to store cremation remains in a decorative urn. Often, this urn is located in the home of a surviving loved one. The urn may be displayed on a mantle or shelf, for example.

While these urns provide a way to remember person or pet while at home, the effect is often not sufficient for those who feel a desire to have a connection with their departed loved ones. Therefore, what is needed is an improved means for storing cremation remains, in accordance with the psychological need of humans to mourn.

### SUMMARY OF THE INVENTION

The present invention provides a small urn, referred to as a “pocket urn.” The pocket urn serves as a keepsake for the survivors of a loved one. Ashes, or other material from the deceased, such as hair, are stored in the pocket urn. The pocket urn is then able to be carried in a purse, suitcase, or pocket, allowing a user to hold the pocket urn in their hand whenever they feel the need to. By holding the pocket urn, they can make a psychological connection to their loved one which may comfort the user while going through the grieving process.

In one aspect of the invention, the invention provides an urn comprising:

a body composed of an exotic hard wood;

an upper cavity formed within the body;

a lower cavity formed directly below the upper cavity, and having a smaller diameter than the upper cavity; and

a plug composed of an exotic hard wood, and having a diameter larger than the diameter of the lower cavity, whereby the plug fits securely within the upper cavity, thereby securing contents stored within the lower cavity.

In another aspect of the invention, the body and plug are made of Blackwood African wood.

In another aspect of the invention, the body and plug are made of Red Mallee wood.

In another aspect of the invention, the body and plug are made of Coolabah wood.

In another aspect of the invention, the body is made of burl wood.

In another aspect of the invention, the invention provides a method for making an urn comprising the steps of:

forming a body from a piece of exotic hard wood;

sanding the body with coarse sandpaper;

sanding the body with sandpaper with a CAMI standard grit range of 400 to 600;

sanding the body with a cushioned abrasive cloth having an equivalent CAMI grit range of 1,800 to 12,000;

applying a blend of clear lacquer and lacquer thinner to the outer surface of the body; forming an upper cavity and a lower cavity within the body; and

forming a plug, whereby the upper cavity has a larger diameter than the lower cavity, and the plug has a larger diameter than the lower cavity, and a smaller diameter than the upper cavity.

In another aspect of the invention, the invention provides a method for making an urn comprising the steps of:

inserting the urn plug into the upper cavity of the body in a desired orientation; sanding the top portion of the body with a CAMI standard grit range of 400 to 600;

sanding the top portion of the body with a cushioned abrasive cloth having an equivalent CAMI grit range of 1,800 to 12,000;

applying a blend of clear lacquer and lacquer thinner to the top portion of the outer surface of the body;

identifying the desired orientation of the urn plug by placing a first removable indication on the urn plug and a second removable indication on the body, thereby indicating the desired orientation.

removing the urn plug from the body

inserting a bottom plug into the lower cavity, whereby the bottom plug is approximately flush with the outer surface of the bottom portion of the body.

sanding the bottom portion of the body with a CAMI standard grit range of 400 to 600;

sanding the bottom portion of the body with a cushioned abrasive cloth having an equivalent CAMI grit range of 1,800 to 12,000; and

applying a blend of clear lacquer and lacquer thinner to the bottom portion of the outer surface of the body.

In another aspect of the invention, the blend of clear lacquer and lacquer thinner that is applied to the body is approximately 50% clear lacquer, and approximately 50% lacquer thinner.

In another aspect of the invention, the clear lacquer is a cellulous-based lacquer.

In another aspect of the invention, the invention provides a carrying bag for carrying the pocket urn. This carrying bag comprises an outer layer and an inner layer. The inner layer is comprised of a cushioned abrasive, whereby the cushioned abrasive forms a lining that lines the interior of the carrying bag.

In another aspect of the invention, the outer layer of the carrying bag is cloth.

In another aspect of the invention, the outer layer of the carrying bag is leather.

In another aspect of the invention, the outer layer of the carrying bag is vinyl.

In another aspect of the invention, the outer layer of the carrying bag is plastic.

In another aspect of the invention, the cushioned abrasive used for the inner layer of the carrying bag has an equivalent CAMI grit range of 1,800 to 12,000.

### BRIEF DESCRIPTION OF THE DRAWINGS

FIG. 1 shows a top view of a preferred embodiment of the present invention.

FIG. 2 is a perspective view showing the underside of the embodiment of FIG. 1.

FIG. 3 shows a side view of the embodiment of FIG. 1.

FIG. 4 shows a cross section view of the embodiment of FIG. 1.

FIG. 5 shows a cross section view of the embodiment of FIG. 1, after sealing the urn with a plug.

FIG. 6 shows a preferred method of storing the embodiment of FIG. 1.

FIGS. 7A-7I show steps for making an alternative embodiment of the present invention.

### DETAILED DESCRIPTION OF PREFERRED EMBODIMENTS

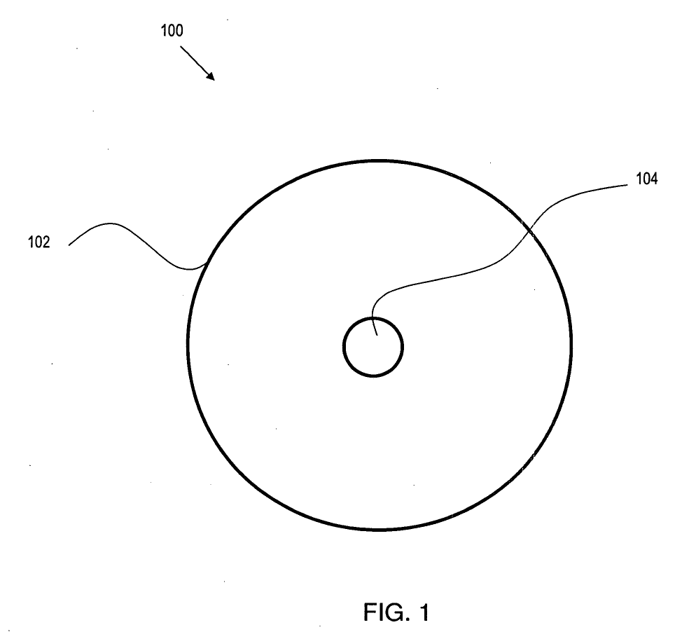

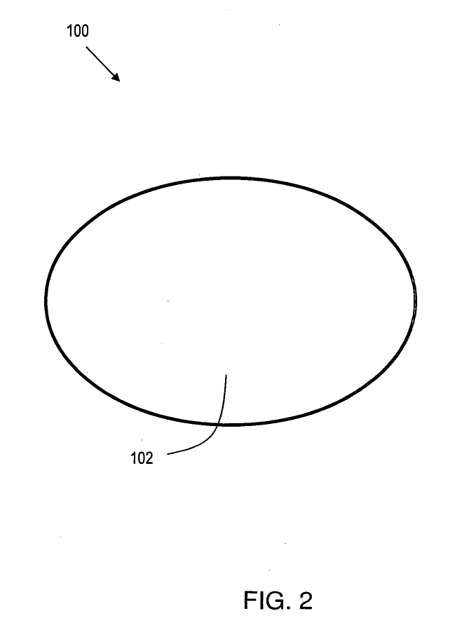

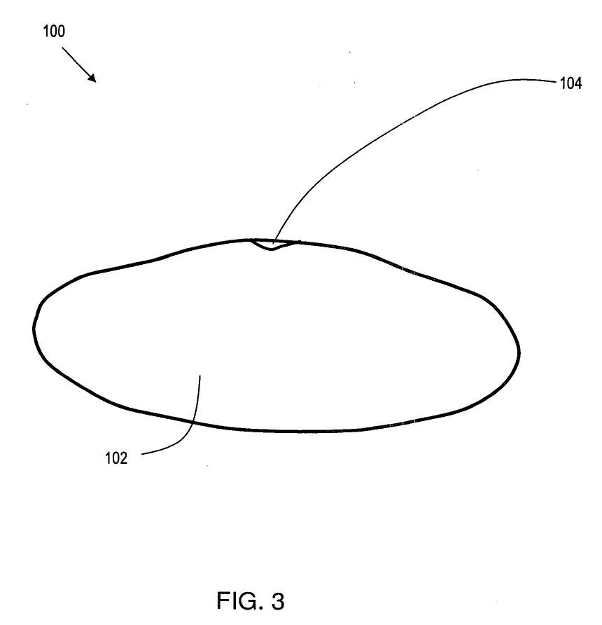

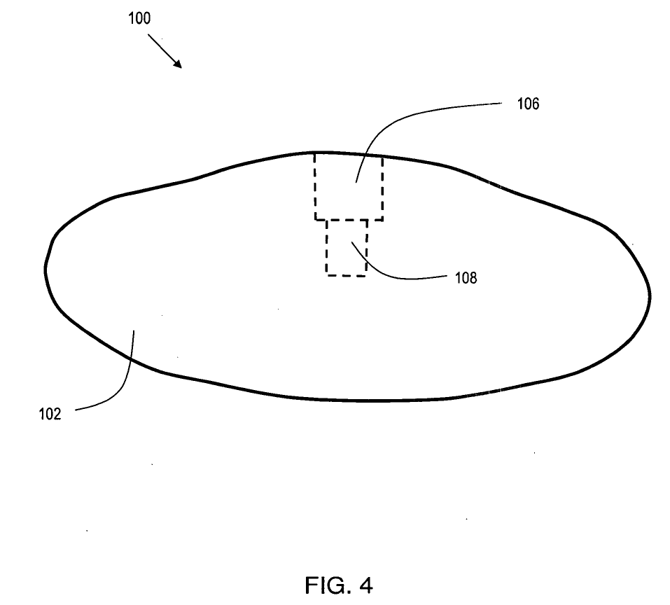

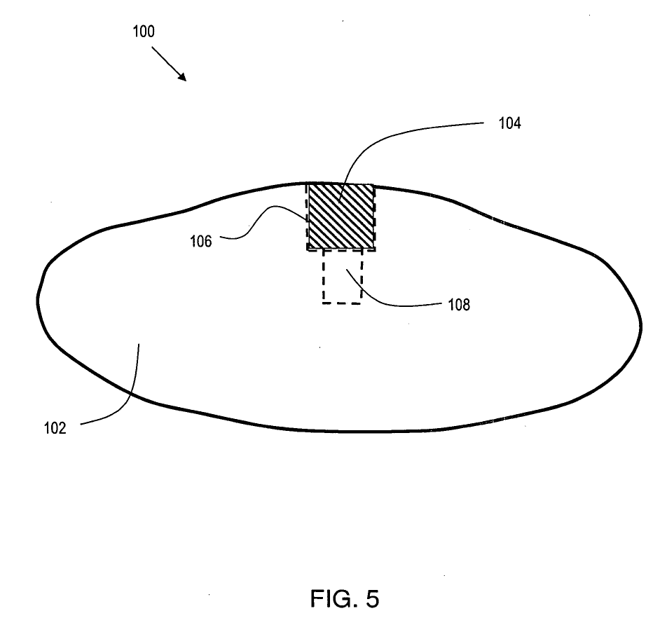

FIGS. 1-5 show various views of the pocket urn 100 of the present invention. The pocket urn 100 comprises a body 102, and plug 104. The body 102 preferably has a rounded underside as shown in FIG. 2. As viewed from the side in FIG. 3, it can be seen that the pocket urn has a generally elliptical, or “saucer shaped” side profile. Urn body 102 is preferably a round, circular body, for convenience of holding or carrying. FIG. 4 shows the cross section of pocket urn 100. Within pocket urn 100 is a cavity comprised of an upper urn cavity 106, and a lower urn cavity 108. The lower urn cavity 108 is located directly below upper urn cavity 106. FIG. 5 shows a cross section view of the urn with urn plug 104 installed. In this case, urn plug 104 fits within the upper urn cavity 106, whereas the lower urn cavity 108 is not occupied by the urn plug 104. This allows lower urn cavity 108 to store cremation remains, hair, or any other suitable material that can be used to remember a deceased loved one.

Making the Pocket Urn

The method of making the pocket urn will now be described in more detail. In a preferred embodiment, an exotic hard wood is used. More specifically, burl wood is preferred. The burl is the result of an unusual growth on any tree characterized by swirling grain patterns, resulting in a very beautiful wood product when finished. In particular, exotic hard woods such as Blackwood African, Coolabah, and Red Mallee yield excellent results. These woods feel heavy in the hand, and the weight of the product has an impact on the consumer's impression with regards to the quality of the pocket urn. If the item is too light, it could leave the impression that it is not worthy of holding the contents that are priceless to its owner. Therefore, heavy woods are best for making the pocket urn. These woods are very durable and will stand up to the stresses that are typically subject to a portable device that is carried in a pocket or purse. While the size of the pocket urn can vary, typically it is less than 3 inches in diameter. Therefore, it is often feasible to make the pocket urn from a piece of scrap wood, using standard woodworking techniques to form the body from a discarded piece of exotic hard wood.

The sandpaper grit values specified in this disclosure are based on the CAMI (Coated Abrasive Manufacturers Institute) standard. This standard establishes the average grit size, as well as the allowable variation from the average. For example, sandpaper with a CAMI grit of 600 has an average particle size of 16 micrometers in diameter.

An extensive sanding process is used in the making of a pocket urn. Sanding starts with coarse grit sandpaper. Following conventional woodworking steps, increasingly finer sandpapers are used until are followed up to a finer grit sandpaper, such as 400 to 600 grit sandpaper. Once the 400-600 grit sandpaper reveals no scratches, a special-purpose sanding cloth is utilized. This special-purpose sanding cloth is in the 1,800 to 12,000 equivalent grit ranges.

The special-purpose sanding cloth used in the method of the present invention is what is known as a cushioned abrasive. A cushioned abrasive is a cloth backed material with a resilient layer upon which a layer of abrasive crystals are affixed.

What is unique about cushioned abrasives is that they do not give any random deep scratches. Instead, they produce an extremely uniform scratch pattern over the entire work surface. When contact pressure is applied, the crystals recede and rotate slightly to present their sharp edges evenly across the surface. Due to the mechanisms involved with a cushioned abrasive, a much larger crystal can be used to achieve a very fine uniform scratch pattern. Therefore, an equivalent grit range is used to describe the performance characteristics of these cushioned abrasives. One suitable cushioned abrasive is MICRO-MESH, manufactured by Micro-Surface, of Wilton, Iowa, USA. The pocket urn is sanded with an increasingly finer grit of special-purpose cushioned abrasive cloth, until an equivalent grit of 12,000 is used.

Once the sanding process is complete, the pocket urn is finished using a blend of 50% lacquer thinner, and 50% clear lacquer. Preferably, the clear lacquer is a cellulous-based lacquer. In a preferred embodiment, the lacquer used is Deft Clear Wood Finish, manufactured by Deft Incorporated, of Irvine, Calif., USA. The mixture of thinner and lacquer is important to provide protection for the wood, while at the same time having a surface that does not feel sticky or tacky when touched.

Once finished, the cavity is formed using a step drill bit. The step drill bit forms a cavity with a smaller diameter lower portion (106, FIG. 4), and a larger diameter upper portion (108, FIG. 4). An urn plug (104, FIG. 1) is cut from similar material that has already been sanded and finished using the aforementioned process. This provides a convenient way to create a plug that will have a reasonable match to the finish of the pocket urn.

Using the Pocket Urn

Remains, such as ashes or hair are placed in the lower urn cavity (108, FIG. 4), and a thin layer of wood glue is then applied to urn plug 104, which is then inserted into upper urn cavity 106. The remains are secured firmly within the pocket urn lower cavity 108 once the glue sets. Note that while the examples used in this disclosure are primarily for a deceased person or pet, the pocket urn also has applications for storing material, such as hair from living persons. For example, if a person had a loved one such as a son or brother leaving for an extended period of time, the pocket urn could be used to store some hair from that person, to provide comfort to the user as necessary.

Storing the Pocket Urn

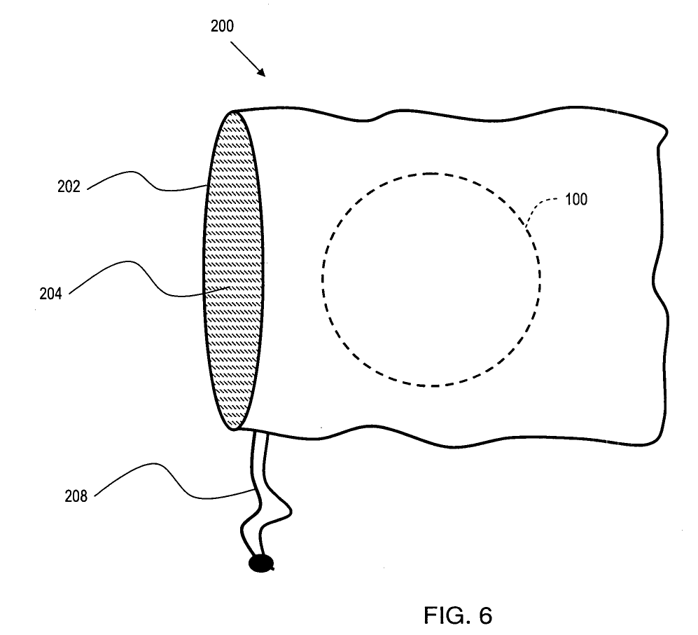

FIG. 6 shows a carrying bag 200 that may optionally be used to carry pocket urn 100 in a purse or pocket. Carrying bag 200 serves to protect pocket urn 100 from scratches. Carrying bag 200 has opening 202 on one end/ Carrying bag 200 is comprised of an outer layer and an inner layer. The outer layer may be any suitable material such as cloth, leather, vinyl, or plastic. The inner layer, which lines the interior of carrying bag 200, provides a high grit equivalent cushioned abrasive 204. This cushioned abrasive 204 serves to continuously polish the pocket urn 100 as it is moved within the carrying bag 200. Consider the case where the pocket urn 100 is placed in carrying bag 200 which is then placed in a purse. As the user of the purse moves contents in and out during daily usage, the carrying bag 200 will be jostled around within the purse. This jostling motion moves the pocket urn 100 against the inner surface of carrying bag 200, which is comprised of cushioned abrasive 204. The result is that the pocket urn 100 is continuously in contact with, and being moved against, the cushioned abrasive 204. This series of movements serves to continuously polish pocket urn 100. Carrying bag 200 optionally has drawstring 208. When the drawstring 208 is pulled, it closes opening 202, preventing the pocket urn 100 from inadvertently coming out of the carrying bag 200.

Making an Alternative Embodiment

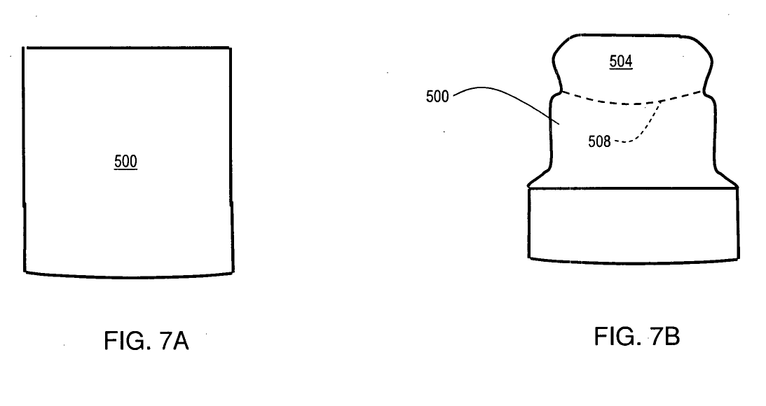

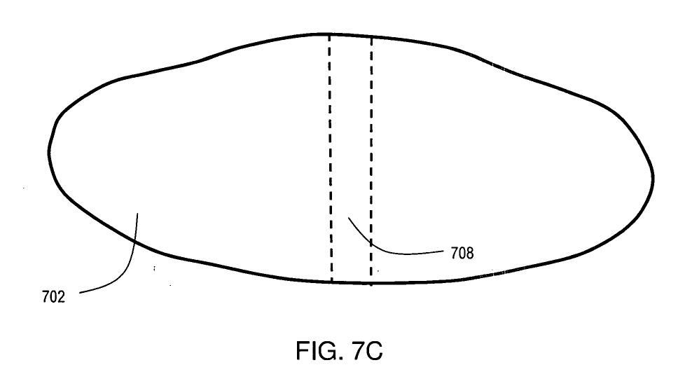

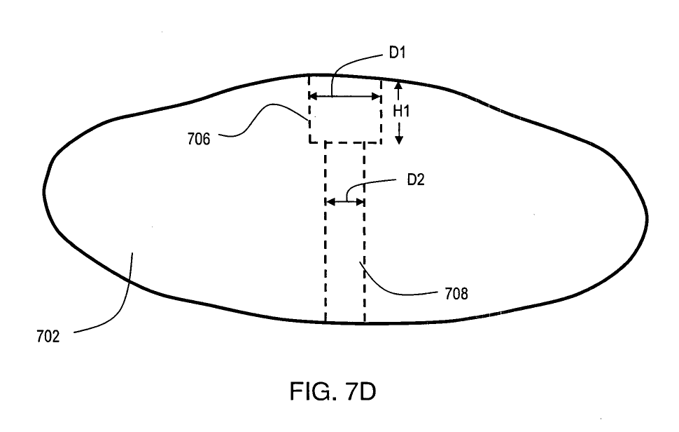

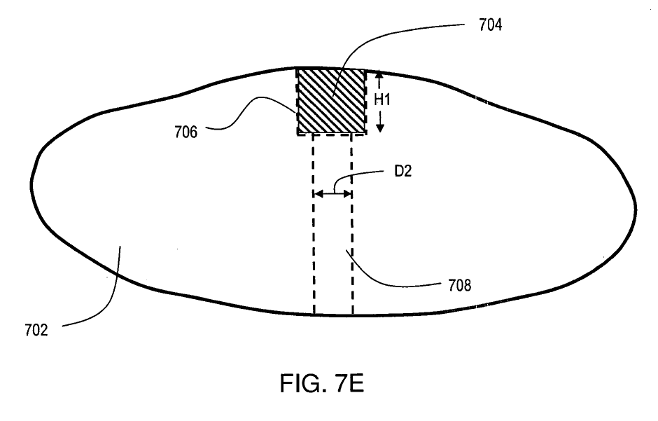

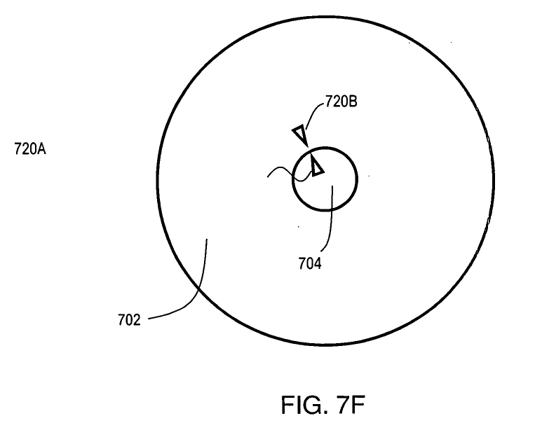

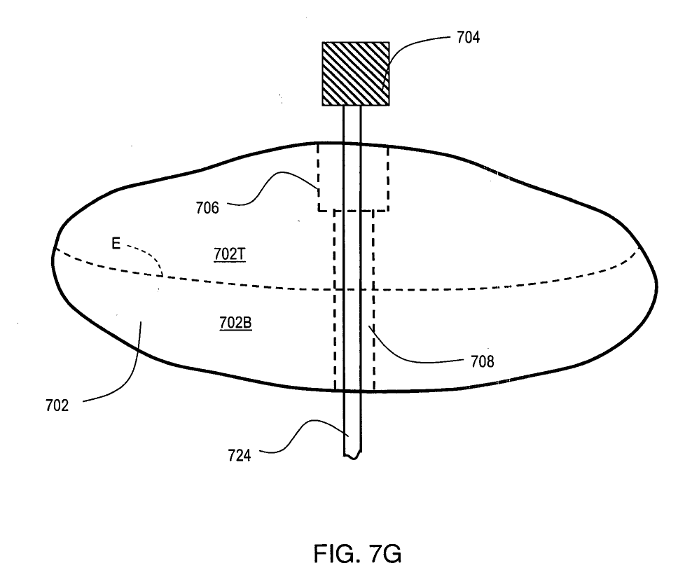

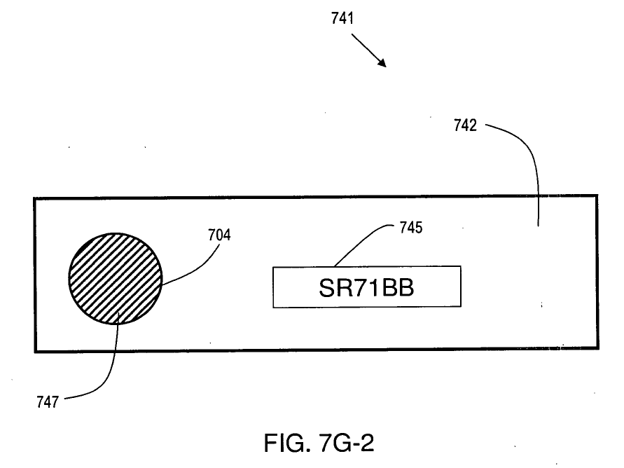

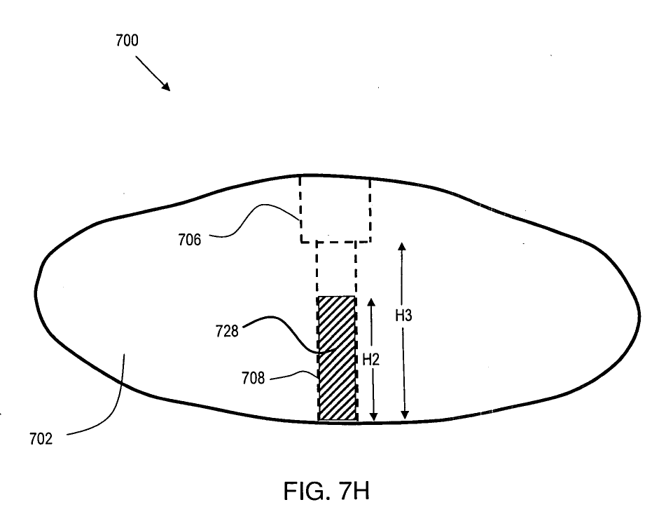

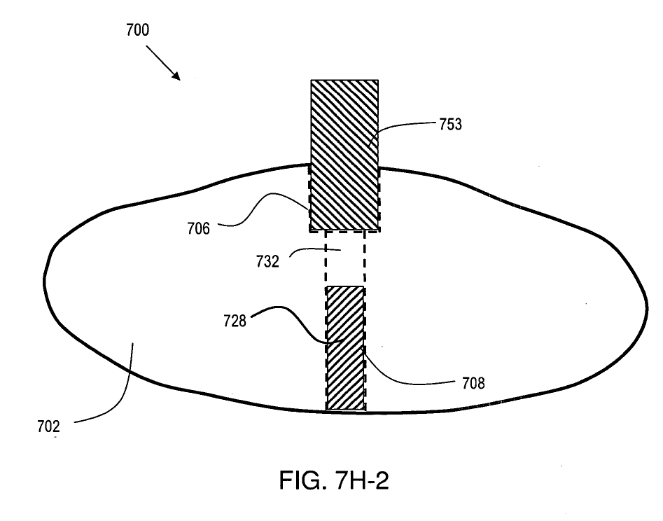

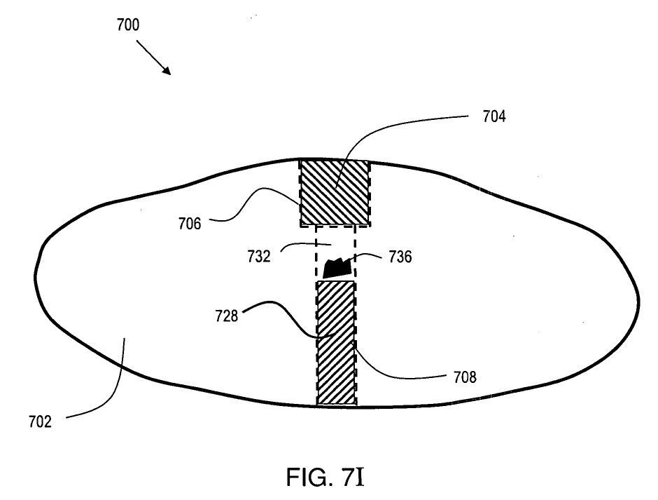

FIGS. 7A-7I show steps for making an alternative embodiment of the present invention. The final product is an urn 700 (FIG. 7I) similar to urn 100 shown in FIG. 1. However, the embodiment about to be disclosed as the advantage of improved matching of finish between the plug and body, as will be described in detail in the upcoming paragraphs.

FIG. 7A shows the starting point for making an urn of the present invention as a wood block 500. The block of wood is cut using a tool, such as a lathe, to create a desired urn shape.

FIG. 7B shows an urn body 504 formed within wood block 500 after being cut by a tool. A cut is then made along line 508 to separate the urn body 504 from the wood block 500.

The urn body is then sanded and finished in accordance with the methods described previously.

FIG. 7C shows an urn body 702, similar to urn body 504 after sanding and finishing. The next step in the process is to form a small opening 708 that will ultimately form the lower cavity of the urn. As is indicated in FIG. 7C, small opening 708 traverses urn body 702 from top to bottom.

FIG. 7D shows a subsequent step in making an urn of the present invention. In this step, an upper cavity, or large opening 706 is formed in the top of urn body 702. The large opening 706 extends from the top of urn body 702 to a depth H1, and does not extend all the way to the bottom of the urn as is the case with small opening 708. In one exemplary embodiment, the small opening has a diameter D2 of approximately 0.125 inches, and the large opening has a diameter D1 of approximately 0.375 inches, with depth d being approximately 0.125 inches. Other dimensions may be used without departing from the scope of the present invention.

FIG. 7E shows a subsequent step in making an urn of the present invention. In this step, urn plug 704 is tapped into the large opening 706. Urn plug 704 is preferably cylindrical, and has a diameter approximately the same size as diameter D1 (FIG. 7D) such that it fits snuggly into large opening 706. Urn plug 704 has a height that is approximately the same as depth H1. The travel of urn plug 704 is limited to depth H1, since urn plug 704 has a diameter larger than diameter D2 of small opening 708.

FIG. 7F shows a top view of urn plug 704 inserted into urn body 702. It is desirable that urn plug 704 is cut from the same stock (e.g. the same batch or piece of wood) of wood as urn body 702, so that the urn plug 704 blends in with the urn body 702. When inserting urn plug 704 into urn body 702, it is desirable to align the direction of the grain pattern (not shown) of urn plug 704 and urn body 702. Once the urn plug 704 is inserted into urn body 702 and oriented in the desired position such that the grain of urn plug 704 and urn body 702 is aligned, the top side of urn body 702 is sanded and finished in accordance with the methods described previously. The urn plug 704 and urn body 702 are then each marked with a removable indication 720A and 720B respectively. This indication will help the user identify the desired orientation of the urn plug 704 when sealing the urn in an upcoming step. There are various means for making removable indications 720A and 720B, such as a light pencil mark, grease pencil, or stickers, to name a few. Any method will work, so long as the mark can be removed easily, and without damage to the finish of the urn plug 704 and urn body 702.

FIG. 7G shows a subsequent step in making an urn of the present invention. In this step, urn plug 704 is removed from urn body 702. Imaginary line E is shown, which circumscribes the urn body 702, dividing the urn body 702 into a top portion 702T, and a bottom portion 702B. At this step, the top portion 702T of urn body 702 is sanded and finished, but bottom portion 702B of urn body 702 has not yet had its final sanding and finishing. A rod 724 is inserted into small opening 708 from the bottom side (702B) of urn body 702 and is pushed against urn plug 704 to remove urn plug 704 from the urn body 702.

FIGS. 7G-2 shows a subsequent step in making an urn of the present invention. In this step, urn plug 704 is secured via plug holder 741. Plug holder 741 comprises flange 742, and cavity 747 which securely receives urn plug 704. Flange 742 is preferably made of a high quality plywood. Flange 742 preferably has identification label 745 attached thereto. The plug holder 741 serves two purposes. Wood can change shape slightly when a new surface is exposed via sanding. By placing urn plug 704 into cavity 747, the shape of urn plug 704 is preserved as substantially circular, and the “ovaling” that normally occurs with a cut or sanded circular piece of wood is prevented. The identification label 745 is used to identify urn plug 704, and ensure that the urn plug 704 is shipped to the customer with the corresponding urn from which urn plug 704 was cut. In a preferred embodiment, the flange 742 is about the same thickness as urn plug 704. The urn plug can therefore be easily removed from plug holder 741 when it is desired to permanently seal the contents of the urn 700.

FIG. 7H shows a subsequent step in making an urn of the present invention. In this step, a bottom plug 728 is inserted into small opening 708 and glued into place such that it is flush with the bottom surface of urn body 702. The bottom plug 728 is preferably cylindrical, and has diameter approximately the same as diameter D2 (FIG. 7D) of small opening 708. Bottom plug 728 has height H2, which is less than the distance H3 from the bottom surface of urn body 702 to the bottom of large opening 706. The difference between H3 and H2 forms the storage cavity 732 (FIG. 71) of the urn when assembly is complete. The bottom portion 702B (FIG. 7G) is then sanded and finished to completion. At this point, the urn 700 is complete and ready for use. In general use, the urn is shipped to a user (e.g. a funeral home) as shown in FIG. 7H, with the urn plug 704 (FIG. 7G) removed. The user inserts keepsake material (e.g. ashes from a cremation) into the urn, and seals it.

FIGS. 7H-2 shows a subsequent step in making an urn of the present invention. In this step, a temporary plug 753 is placed in the urn 700. This would typically be done prior to shipping the urn 700 to a customer. The temporary plug 753 is considerably longer than the depth H1 (FIG. 7E). This temporary plug 753 serves to preserve the shape of large opening 706 while the urn plug 704 is not in place. In one embodiment of the present invention, a kit is supplied to the customer. The kit comprises an urn 700 that is shipped to the customer with the temporary plug 753 in place as shown in FIGS. 7H-2. The kit also comprises the corresponding urn plug 704, which is placed in plug holder 741 and shipped along with urn 700. Upon receipt, the customer can than remove the temporary plug 753, insert desired contents into the urn (as shown in FIG. 71 that follows), and remove the urn plug 704 from the plug holder 741, and use it to plug the urn 700.

FIG. 7I shows the final step of sealing keepsake material 736 into storage cavity 732 of urn 700. Urn plug 704 is then preferably glued into place with the alignment indicated by indications 720A and 720B (FIG. 7F). Indications 720A and 720B are then removed. The result is an urn with an urn plug 704 that blends in very well with the surrounding urn body 702, since the urn plug 704 was cut from similar stock as urn body 702, and both urn plug 704 and urn body 702 were sanded and finished at the same time, providing for improved consistency in the finish.

As can be seen from the aforementioned description and drawings, the present invention provides a convenient apparatus for portably carrying cremation remains, referred to as a pocket urn. The present invention also provides a method for making the pocket urn. Finally, the present invention provides a means for storing the pocket urn, with a specially designed carrying bag.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An urn comprising:
a body, said body composed of an exotic hard wood;
an upper cavity formed within said body;
a lower cavity formed directly below said upper cavity, said lower cavity having a smaller diameter than said upper cavity; and
an urn plug having a diameter larger than the diameter of said lower cavity, whereby said plug fits securely within said upper cavity, thereby securing contents stored within the lower cavity.

2. The urn of claim 1, wherein the body and urn plug are made of Blackwood African wood.

3. The urn of claim 1, wherein the body and urn plug are made of Red Mallee wood.

4. The urn of claim 1, wherein the body and urn plug are made of Coolabah wood.

5. The urn of claim 1, wherein the body is made of burl wood.

6. A method for making an urn comprising the steps of:
forming a body from a piece of exotic hard wood having a grain pattern, the body having a top portion, a bottom portion, and an outer surface;
sanding the body with coarse sandpaper;
sanding the body with sandpaper with a CAMI standard grit range of 400 to 600;
sanding the body with a cushioned abrasive cloth having an equivalent CAMI grit range of 1,800 to 12,000;
applying a blend of clear lacquer and lacquer thinner to the outer surface of the body;
forming an upper cavity and a lower cavity within said body; and
forming an urn plug, whereby the upper cavity has a larger diameter than the lower cavity, and said plug has a larger diameter than said lower cavity.

7. The method of claim 6, wherein the blend of clear lacquer and lacquer thinner is approximately 50% clear lacquer, and approximately 50% lacquer thinner.

8. The method of claim 6, wherein the clear lacquer is a cellulous-based lacquer.

9. The method of claim 6, wherein the step of forming the urn plug comprises the step of cutting an urn plug from wood of the same stock used to form the body.

10. The method of claim 9, wherein the sanding steps are performed first to the top portion of the body, and then to the bottom portion of the body.

11. The method of claim 10, wherein the steps of sanding the body with sandpaper with a CAMI standard grit range of 400 to 600 and the step of sanding the body with a cushioned abrasive cloth having an equivalent CAMI grit range of 1,800 to 12,000 comprises:
sanding the top portion of the body with a CAMI standard grit range of 400 to 600;
sanding the top portion of the body with a cushioned abrasive cloth having an equivalent CAMI grit range of 1,800 to 12,000;
sanding the bottom portion of the body with a CAMI standard grit range of 400 to 600; and
sanding the bottom portion of the body with a cushioned abrasive cloth having an equivalent CAMI grit range of 1,800 to 12,000.

12. The method of claim 11, further comprising the steps of:
inserting the urn plug into the upper cavity of the body in a desired orientation;
sanding the top portion of the body with a CAMI standard grit range of 400 to 600;
sanding the top portion of the body with a cushioned abrasive cloth having an equivalent CAMI grit range of 1,800 to 12,000;
applying a blend of clear lacquer and lacquer thinner to the top portion of the outer surface of the body;
identifying the desired orientation of the urn plug by placing a first removable indication on the urn plug and a second removable indication on the body, thereby indicating the desired orientation.
removing the urn plug from the body
inserting a bottom plug into the lower cavity, whereby the bottom plug is approximately flush with the outer surface of the bottom portion of the body.
sanding the bottom portion of the body with a CAMI standard grit range of 400 to 600;
sanding the bottom portion of the body with a cushioned abrasive cloth having an equivalent CAMI grit range of 1,800 to 12,000; and
applying a blend of clear lacquer and lacquer thinner to the bottom portion of the outer surface of the body.

13. The method of claim 12, further comprising the step of removing the first and second removable indications.

14. A carrying bag for carrying the urn of claim 1, said carrying bag comprising an outer layer and an inner layer, said inner layer comprised of a cushioned abrasive, whereby the cushioned abrasive forms a lining that lines the interior of the carrying bag.

15. The carrying bag of claim 14, wherein said outer layer is cloth.

16. The carrying bag of claim 14, wherein said outer layer is leather.

17. The carrying bag of claim 14, wherein said outer layer is vinyl.

18. The carrying bag of claim 14, wherein said outer layer is plastic.

19. The carrying bag of claim 14, wherein said cushioned abrasive has an equivalent CAMI grit range of 1,800 to 12,000.

20. The carrying bag of claim 14, further comprising a drawstring, whereby pulling the drawstring closes the opening in the carrying bag, thereby preventing contents of the carrying bag from inadvertently coming out of the carrying bag.

21. The method of claim 9, further comprising the steps of:
placing a temporary plug into said upper cavity; and
placing said urn plug in a plug holder, thereby preserving the shape of said upper cavity, and said urn plug.

22. A kit for conveniently storing cremated remains in a portable manner, comprising:
at least one urn of claim 1;
at least one carrying bag of claim 14;
at least one plug holder, each said at least one plug holder comprising an urn plug placed therein; and
a temporary plug placed in the upper cavity of each said at least one urn.
